(19) United States
(12) Patent Application Publication
(10) Pub. No.: US 2009/0046099 A1
(43) Pub. Date: Feb. 19, 2009

(54) REAL-TIME DISPLAY SYSTEM

(75) Inventors: Anthony Duca, Carlsbad, CA (US); Philip Lunn, Santa Monica, CA (US); Henrik Wann Jensen, Harlev (DK); Thomas Teger, Orange, CA (US)

Correspondence Address: KNOBBE MARTENS OLSON & BEAR LLP, 2040 MAIN STREET, FOURTEENTH FLOOR, IRVINE, CA, 92614, US

(73) Assignees: Bunkspeed, Carlsbad, CA (US); Luxion

(21) Appl. No.: 11/939,486

(22) Filed: Nov. 13, 2007

Related U.S. Application Data
(60) Provisional application No. 60/865,615, filed on Nov. 13, 2006.
(60) Provisional application No. 60/902,997, filed on Feb. 22, 2007.

(51) Int. Cl. G06T 15/50

(52) U.S. Cl. 345/426

(57) ABSTRACT

An apparatus and method for displaying photographic images in real-time is disclosed. Traditionally, ray tracing algorithms produce photographic images, but not in real-time. In one embodiment of the present inventions, shadows and lighting can be altered in real-time, and photographic images appear as an interactive photographic image.

### CROSS-REFERENCE TO RELATED APPLICATIONS

The present application claims the benefit of U.S. Provisional Patent Application Ser. No. 60/865,615, filed on Nov. 13, 2006, and U.S. Provisional Patent Application Ser. No. 60/902,997, filed on Feb. 22, 2007, which are hereby incorporated by reference in their entirety.

### BACKGROUND OF THE INVENTION

1. Field of the Invention

The present invention generally relates to the field of computer graphics. More particularly, the invention relates to generating photographic images.

2. Description of the Related Art

A variety of programs for rendering and display of images have been developed. Many of these are implemented in animation systems such as video games and movies. Another application of image rendering involves product design and development, where design tools interface with a rendering system to display an image of the product being designed.

Global illumination produces realistic lighting in 3D scenes. Global illumination algorithms take into account both direct illumination from a light source as well as indirect illumination reflected by other surfaces in the scene. As a result, images rendered using global illumination appear more photographic. Further information related to global illumination can be found in Jensen, Henrik Wann, Realistic Image Synthesis Using Photon Mapping, A K Peters, 2001, which is hereby incorporated by reference for all purposes.

Ray tracing and photon mapping are examples of global illumination algorithms. Ray tracing is one type of algorithm that can be used to produce global illumination. It traces the light along a path from an imaginary eye through each pixel in a virtual screen. As each ray is cast from the eye, it is tested for intersection with objects within the scene. In the event of a collision, the pixel's values are updated, and the ray is either recast or terminated based on material properties and maximum recursion allowed. When a ray hits a surface, it can generate a new type of ray based on whether the new ray is a reflected, refracted, or absorbed.

Ray tracing algorithms have been used to create photographic images, but historically they have been too inefficient to produce photographic images in real-time. Some graphics programs allow a user to manipulate an image by changing the direction of view, changing the color of all or some of the product, and the like. However, the image being manipulated may be more like a flat shading or cartoon than a high quality digital image. For example, after a user manipulates a low quality image to produce a final static image, a separate process is invoked to render a high quality version of the same image in a new window. The new image is non-manipulatable, and if the user wants to see a high quality image with a different appearance, they must return to the low quality image to make changes, and then render a new high quality image.

### SUMMARY OF THE INVENTION

The system, method, and devices of the invention each have several aspects, no single one of which is solely responsible for its desirable attributes. Without limiting the scope of this invention as expressed by the claims which follow, its more prominent features will now be discussed briefly. After considering this discussion, and particularly after reading the section entitled “Detailed Description of the Preferred Embodiment” one will understand how the features of this invention provide advantages that include the ability to make changes to a virtual 3D image while watching the image update in real-time.

Some embodiments of the present invention are directed to an apparatus and method for generating a photographic image in real-time. Another embodiment is directed to updating a photographic image in real-time based on user input. One embodiment is able to interactively manipulate a photographic illuminated scene in real-time in such a way as to appear to the user as an interactive photograph. One embodiment uses high dynamic range image illumination to provide all of the lighting in the scene. All shadows in the scene, ground as well as self-shadows, are then created in real-time.

### BRIEF DESCRIPTION OF THE DRAWINGS

FIG. 1 is a flowchart illustrating a process of setting up an initial scene based on a model and rendering any changes to the scene in real-time.

FIG. 2 is a flowchart illustrating portions of the process of FIG. 1, including inputting a 3D image and generating a photographic image in real-time.

FIG. 3 is a flowchart illustrating one example of a method of updating an image in real-time according to user actions such as in the process of FIG. 1.

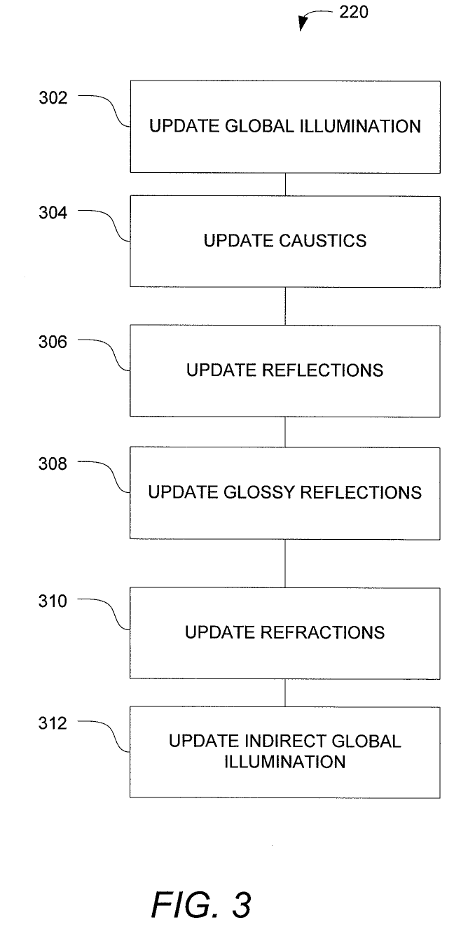

FIG. 4 is a block diagram illustrating one embodiment of a system configured to perform the methods illustrated in FIGS. 1-3.

### DETAILED DESCRIPTION OF THE PREFERRED EMBODIMENT

The following detailed description is directed to certain specific embodiments of the invention. However, the invention can be embodied in a multitude of different ways as defined and covered by the claims.

The term “real-time” as used herein when referring to image manipulation of the interactive photographic scene means that the image changes under user control in a single display window and appears photographic for a majority of the time a user would view the virtual object when evaluating the design of a CAD defined virtual object. The term “photographic” as used herein means the image being manipulated appears in the manipulation window in a manner that is substantially indistinguishable from a digital image obtained with conventional photographic techniques of an actual physical object.

As objects are modeled in 3D modeling or computer aided design systems, the rendering of the objects in response to user actions may be viewed in terms of a trade-off between responsiveness and quality. One embodiment includes a real-time ray tracing system configured to compute refractions, glossy reflections, shadows, and indirect illumination such as caustics and color bleeding. In computer graphics and 3D rendering, color bleeding is the phenomenon in which objects or surfaces are colored by reflection of colored light from nearby surfaces. The transmission of light through other objects (refraction) is computed using Snell's law:

?₁ sin ?₁=?₂ sin ?₂

where ?₁ and ?₂ are the indices of refraction for the current medium and the medium the light is entering, and ?₁ and ?₂ are the incidence and refracted angle respectively. Reflections are computed by tracing rays in the reflected direction. Shadows are computed by tracing one or more rays to lights in the scene in order to estimate their visibility. Glossy reflections, caustics and indirect illumination are computed by Monte Carlo ray tracing, where a sample ray is cast in order to estimate the value of the following reflection integral (See Jim Kajiya, “The Rendering Equation”, Proceedings of SIGGRAPH 1986, pages 143-150):

L(x,\vec{w})=∫fᵣ(x,\vec{w},\vec{w}′)(\vec{n},\vec{w}′)dw′

where L(x,\vec{w}) is the radiance at x in direction \vec{w}, fᵣ(x,\vec{w},\vec{w}′) is the Bidirectional Reflectance Distribution Function (BRDF) expressing the amount of light incident at x from direction \vec{w}′ that is reflected in direction \vec{w}, and \vec{n} is the surface normal at x. Desirably, one embodiment provides real-time rendering and editing of parameters with real-time feedback as the user makes changes to the underlying object.

Generally, to provide substantially real-time object or image manipulation, rendering quality may be reduced. However, it has been found that high quality photographic images may be generated of such 3D models by updating direct global illumination and indirect illumination along with other aspects such as caustics, refractions, reflections, and glossy reflections. In one embodiment, subsurface scattering with ray traced illumination is also rendered. In one embodiment, updating the rendering of these aspects, along with other image properties of the displayed photographic image can be desirably performed in real-time.

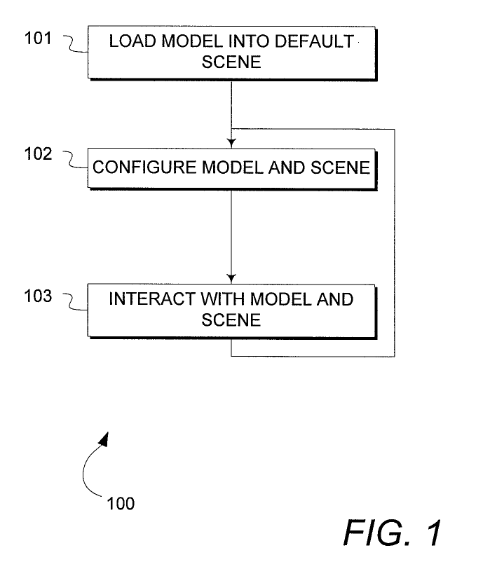

FIG. 1 is a flowchart illustrating an overall process 100 of loading an image and updating the photographic image in real-time. For example, beginning at a block 101, a processor loads a 3D model into a default scene. The loading may include loading default materials, default lighting, and a default camera angle 6. A photographic image can be rendered with the default settings. Next at a block 102, a user can configure and modify aspects of the scene while continuing to view scene updates in real-time. For example, a user can modify a scene by assigning materials, loading a lighting environment, loading a backplate, or adjusting the camera. As noted above, in one embodiment aspects of the image rendering such as global illumination in the may be updated in real-time as the changes are made. Once the user has completed the configuration changes, the photographic image rendering may be updated in real-time. For example, the processor may apply the ray tracing algorithm and update the photographic image in real-time without requiring the user to make the changes in a low quality environment and hit the render button again.

Moving to a block 103, the user may tweak or change materials or otherwise interact with the model and scene. In response to a user selection for a new material, the object is automatically displayed as having the new selected material. Furthermore, after a new material is selected, the object is displayed having the new material and new lighting and ray tracing information is calculated and displayed for the object. The properties of a selected material can be copied from one material element to another using the mouse in a copy (left mouse) and paste (right mouse). The user may also adjust the lighting environment.

In one embodiment, the scene interaction may include allowing the user to adjust the camera interactively. In one embodiment, the camera is locked so the user does not adjust the camera view so as to be below the ground surface and the object “feels” attached to the ground. Real-time accurately calculated depth of field can be applied. A focus point of the camera can be chosen interactively and the focal stop can be applied to choose the distance in focus. In one embodiment, a configuration switch may be provided that controls display of the camera distance from the object, allows picking of the focus point and the f stop of the lens. In one embodiment, a user may select a camera or viewing position via an input device that is connected directly or indirectly to the microprocessor. For example, in one embodiment, a user may “click” using a button in the scene, to have camera position zoom in, zoom out, rotate, or move in the three dimensional display space. In one embodiment, the view of the object is changed with a left mouse button click and movement from left to right. When the user stops the camera, the scene on the screen continues to increase in clarity until it is indistinguishable from a photo.

The model and scene interaction may also include adjusting a backplate, the scene background, interactively. In one embodiment, the object can be moved in the scene without disturbing the backplate. In one embodiment, it is possible to dynamically and in real-time choose the backplate. In one embodiment, the processor automatically updates the color of the object or a portion thereof as user is adjusting a color wheel. In one embodiment, a background.jpg file may be provided that can be viewed in the background as the backplate. In some such embodiments, the background image never changes, it is like a back plate. In one embodiment of an offline high resolution viewer, a user interface may be provided that allows making the ground reflective with the index of refraction of water so as to show a reflection of the object in the ground.

The model and scene interaction may also include loading lighting and changing the scene. Adjusting the lighting environment may include adjusting a HDR background, changing the light based on time of day and latitude and longitude, changing the position of the directional light, or changing the resolution.

Desirably, as changes to the scene are made in real-time, the user does not need to hit a button to create a high quality image. Traditional methods require that some post processing. Instead in one embodiment, the lighting, shadows, and reflections are updated in real-time as the user interacts with the scene. In one embodiment, the user may be provided a user interface to allow switching between high quality antialiased mode where the movement is slower but the quality is much higher and low quality mode that allows faster interaction and quality increases when the camera is stopped.

In one embodiment, a display module is comprised of various modules that are collectively referred to as a real-time display module. As can be appreciated by one of ordinary skill in the art, each of the modules in the display module may comprise various sub-routines, procedures, definitional statements, and macros. Each of the modules are typically separately compiled and linked into a single executable program. Therefore, the following description of each of the modules is used for convenience to describe the functionality of the display module. Thus, the processes that are undergone by each of the modules may be arbitrarily redistributed to one of the other modules, combined together in a single module, or made available in a shareable dynamic link library. It will be appreciated that each of the modules could be implemented in hardware.

In one embodiment, the display module is configured to execute on a processor. The processor may be any conventional general purpose single- or multi-chip/core microprocessor such as a Pentium® family processor, an 8051 processor, a MIPS® processor, a Power PC® processor, or an ALPHA® processor. In addition, the processor may be any conventional special purpose microprocessor such as a digital signal processor.

In one embodiment, a display module displays an interactive photographic image of a virtual object in a background. In one embodiment, the display module is configured to be executed on a general purpose computer such as a personal computer or workstation that comprises a processor in communication with persistent and non-persistent memory or storage, one or more user input devices, and a display.

In this embodiment, a user may view a rendering of virtual objects in a three-dimensional display space. The user may interact with the model in the real-time environment via the display module. The interactive scene may be a ray tracing/photon mapping and global illumination rendering of a selected object or objects in the context of a selected three dimensional display space. Upon receiving user input for modifying a displayed object,

In one embodiment, the entire photographic scene can run in web browser with Macromedia Flash based controls or as a stand alone application or in conjunction with many authoring tools.

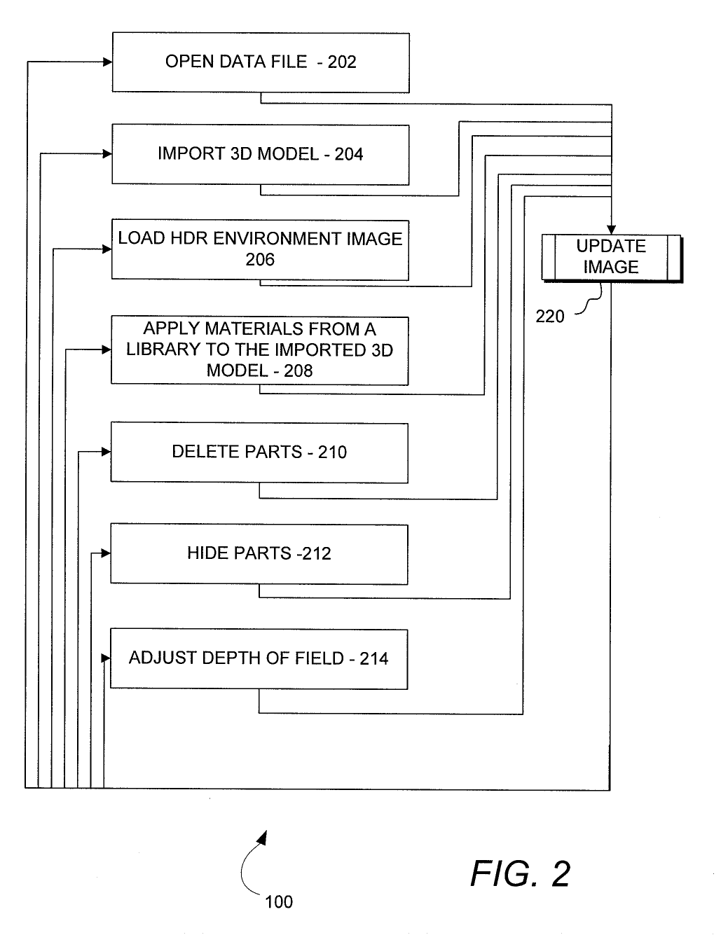

FIG. 2 further illustrates one example of the process 100 of interacting with a model and rendering an interactive photographic image in real-time. In one embodiment, a 3D image is received as an input and rendered as a photographic image that can be manipulated in real-time. For example, at a block 202 a user may open a data file to apply to the current model such as a data file describing a model and scene. Next at a block 220, a displayed photographic image may be updated in real-time.

At a block 204, a user imports a 3D digital model into the real-time ray tracing environment. In one embodiment, CAD data can be received as input. The CAD data can include information defining an object to be displayed in the 3D display space. Thus, the object being displayed may not physically exist at the time the interactive photograph image is generated and manipulated herein. The process 100 then proceeds to the block 220 in which the displayed photographic image is updated in real-time.

At a block 206, HDR (high dynamic range) environment image is loaded. As used herein, “HDR” refers to images or image rendering using more than 16 bits per channel (intensity or color depending on the color space of the particular image). In one embodiment, 360 degree spherical HDR images are used as the entire light source for the 3D scene in real-time, and there are no lights in the scene. Through mathematical calculations, the HDR image can be used as the light source to interactively cast shadows onto the object itself and to other objects in the scene. In one embodiment, it is possible to turn off light source and only use HDR for lighting. Shadows on the ground may be cast by the image as the light source. Global illumination may be calculated on the object from the image in real-time.

By using an HDR spherical image of the location of the viewer, the viewer sees the computer graphic representation of the object in the same light as their location. The HDR 360 degree image is reconstituted as to look correct to the untrained eye. In one embodiment, the spherical image can be rotated by use of the shift and arrow keys in either direction in increments. The spherical HDR image can be hidden with a keystroke and the background color changed while still retaining all the reflections of the image in the object. Brightness and gamma can be adjusted interactively and dynamically in the real-time environment. The display software dynamically alters the spherical image such that the lower hemisphere appears under the object as a floor or ground. The spherical HDR image can be flattened, and the lighting and shadows can then be updated in real-time. Using the flattened HDR image gives the impression that an object is embedded in the scene. Using a hot key or menu command, the background image can be changed by picking the next HDR image from a list or by going back and forth through a list. The process 100 then proceeds to the block 220 in which the displayed photographic image is updated in real-time.

At a block 208, materials from a material library can be selected and imported into the model. Materials used as a base material set are represented with the same environment as the object. The type of material and the material properties can be altered via a menu selection. Material shaders are based on measured accurate material definitions. Each material has scientifically accurate parameters which may be altered. The materials can include glass and metal. In one embodiment, a material may be designated or assigned to each object in the three-dimensional display space including those objects that are imported via CAD data. In one embodiment, metallic paint is represented by a base color and a metal flake color selected via a standard color picker. The paint displayed with diffuse, glossy, and specular components. The paint and lighting can be changed interactively with the results displayed in real-time. The process 100 then proceeds to the block 220 in which the displayed photographic image is updated in real-time.

The process 100 may also include other user interactions. For example, at a block 210, parts of the modeled object may be deleted. At a block 212, parts of a modeled object may be hidden. At a block 214, the user may adjust the depth of field of the image of the object. In response to the acts associated with any of blocks 210, 212, or 214, the 100 proceeds to the block 220 in which the displayed photographic image is updated in real-time.

A user may also take a screenshot of the photographic image or to click a render button that creates a high quality image. In one embodiment, any key can be designated to activate a “screenshot” that is saved into a specific folder. Screenshots can be designated as jpg, 16 bit tiff, and 32 bit HDR image format. Gamma and brightness of the overall image or the HDR image environment individually can be altered interactively prior to taking the screenshot.

In one embodiment a user can interact with the virtual photograph. A user may dynamically and in real-time update a display object having new color or type of material, a type of exposure, a depth of field, or a type of background.

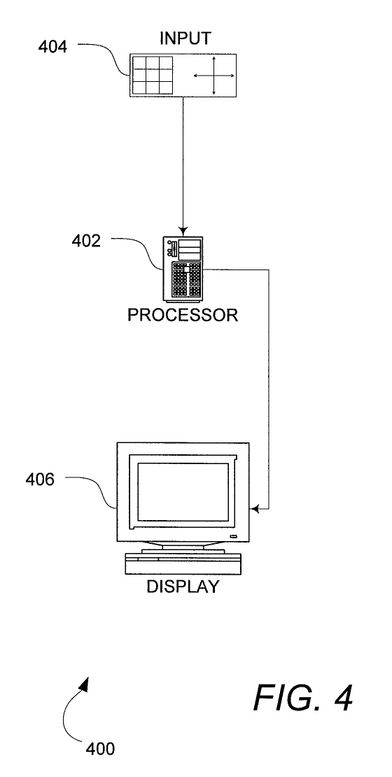

FIG. 4 illustrates one example of a system 400 for performing the methods described herein. For example, in one embodiment, the system comprises a processor 402 configured to receive user commands from an input device 404. The processor 402 may display data on a display 406. The processor 402 may comprise any suitable computer processor including a general purpose or special purpose computer processor module along with program and data storage in communication with the processor module. The input module 404 may comprise one or more suitable input devices such as a mouse, keyboard, or touch or stylus-based input pad. The display 406 may comprise one or more suitable display devices such as a cathode-ray tube (CRT) display, a liquid crystal display, or any other display device that can display image data.

Those skilled in the art will recognize that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The modules may be written in any programming language such as, for example, C, C++, BASIC, Visual Basic, Pascal, Ada, Java, HTML, XML, or FORTRAN, and executed on an operating system. C, C++, BASIC, Visual Basic, Pascal, Ada, Java, HTML, XML and FORTRAN are industry standard programming languages for which many commercial compilers can be used to create executable code.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. A method of viewing a virtual object comprising:
rendering a photographic image of an imported object;
inputting at least one change to said image;
updating the illumination in the said image, wherein said updating comprises updating both direct illumination from a light source as well as indirect illumination reflected by other surfaces in the image; and
rendering a second photographic image of said image in real-time incorporating said change.

2. The method of claim 1, wherein updating the illumination in the said image comprises updating direct and indirect illumination, and updating at least one of caustics, refractions, reflections, and glossy reflections.

3. The method of claim 1, wherein said rendering comprises high dynamic range rendering.

4. The method of claim 3, wherein high dynamic range rendering comprises:
loading a high dynamic range spherical image;
flattening the high dynamic range image; and
adding shadows to the high dynamic range image in real-time.

5. The method of claim 1, wherein inputting at least one change to said image comprises changing the backplate of the image.

6. The method of claim 1, wherein inputting at least one change to said image comprises changing the camera angle on the image.

7. The method of claim 1, wherein inputting at least one change to said image comprises changing the lighting in the image.

8. The method of claim 1, wherein inputting at least one change to said image comprises changing the materials used on the objects in the image.

9. The method of claim 8, wherein changing the materials comprises:
displaying metallic paint on objects in the image with diffuse, glossy, and specular components; and
changing the parameters of the paint interactively.

10. The method of claim 1, wherein rendering a second photographic image comprises rendering subsurface scattering with ray traced illumination.

11. A graphics apparatus comprising:
a module configured to import a virtual 3D image;
a high dynamic range image module to provide illumination for the imported image;
a global illumination module to calculate a ray tracing of the imported image, wherein calculating a ray tracing comprises updating both direct illumination from a light source as well as indirect illumination reflected by other surfaces in the image; and
a display module configured to interactively display the imported image in a virtual display space in real-time based upon the illumination and ray tracing.

12. The method of claim 11, wherein calculating a ray tracing comprises updating said global illumination, and updating at least one of caustics, refractions, reflections, and glossy reflections.

13. A method of updating a photographic image comprising:
changing the illumination or viewpoint of an image while viewing the image;
ray tracing the image to determine realistic lighting of the image, wherein said ray tracing comprises updating both direct illumination from a light source as well as indirect illumination reflected by other surfaces in the image; and
displaying the image with the updated lighting in real-time.

14. The method of claim 13, wherein displaying the image with the updated lighting in real-time comprises:
displaying a plurality of shadows in the image based on illumination and viewpoint; and
updating the lighting and shadows in the image in real-time in response to changes in illumination and viewpoint.

15. The method of claim 13, wherein said ray tracing comprises updating said direct and indirect illumination, and updating at least one of caustics, refractions, reflections, and glossy reflections.
